(19) United States
(12) Patent Application Publication
(10) Pub. No.: US 2026/0288028 A1
(43) Pub. Date: Sep. 24, 2026

(54) DEVELOPER SET AND IMAGE FORMING APPARATUS

(71) Applicant: KYOCERA Document Solutions Inc., Osaka (JP)

(72) Inventors: Minoru WADA, Osaka (JP); Kohei TERASAKI, Osaka (JP); Yusuke KURANO, Osaka (JP)

(73) Assignee: KYOCERA Document Solutions Inc., Osaka (JP)

(21) Appl. No.: 19/568,055

(22) Filed: Mar. 16, 2026

(30) Foreign Application Priority Data
Mar. 24, 2025 (JP) 2025-048533

(51) Int. Cl. G03G 9/113; G03G 9/107; G03G 15/01; G03G 15/08

(52) U.S. Cl. CPC G03G 9/1136; G03G 9/107; G03G 9/1139; G03G 15/0865; G03G 15/0121; G03G 15/0189; G03G 2215/0607

(57) ABSTRACT

A first developer contains a first toner and a first carrier containing first carrier particles. A second developer contains a second toner, and a second carrier containing second carrier particles. The first carrier particle has a first carrier core and a first coat layer whose main component is silicone resin, the first coat layer covering the first carrier core. The second carrier particle has a second carrier core and a second coat layer whose main component is silicone resin, the second coat layer being harder than the first coat layer and covering the second carrier core.

### INCORPORATION BY REFERENCE

This application is based upon and claims the benefit of priority from the corresponding Japanese Patent Application No. 2025-048533 filed Mar. 24, 2025, the entire contents of which are hereby incorporated by reference.

### BACKGROUND

The present disclosure relates to a developer set and an image forming apparatus.

An electrophotographic image forming apparatus is equipped with a developing device. The developing device uses a two-component developer stored therein to develop an electrostatic latent image. When the developer stored in the developing device is consumed, the developer is replenished to the developing device, and the replenished developer and the developer originally stored in the developing device are used for developing the electrostatic latent image.

The two-component developer contains toner and carrier. The toner is charged by friction with the carrier.

### SUMMARY

A developer set according to a first aspect of the present disclosure, which is used for developing an electrostatic latent image by a developing device, contains a first developer and a second developer. The first developer is stored in the developing device from beginning of use of the developing device. The second developer is replenished to the developing device after starting use of the developing device. The first developer contains a first toner and a first carrier. The first carrier contains first carrier particles. The second developer contains a second toner and a second carrier. The second carrier contains second carrier particles. The first carrier particle has a first carrier core and a first coat layer. The first coat layer, whose main component is silicone resin, covers the first carrier core. The second carrier particle has a second carrier core and a second coat layer. The second coat layer, whose main component is silicone resin, is harder than the first coat layer and covers the second carrier core.

An image forming apparatus according to a second aspect of the present disclosure includes a developing device, a transfer unit, and a replenishment unit. The developing device uses the developer set described above, so as to develop an electrostatic latent image. The transfer unit transfers the image developed by the developing device to a sheet. The developing device stores the first developer from beginning of use of the developing device. The replenishment unit stores the second developer and replenishes the second developer to the developing device after starting use of the developing device.

### BRIEF DESCRIPTION OF THE DRAWINGS

FIG. 1 is a schematic diagram of an image forming apparatus according to an embodiment.

FIG. 2 is a schematic diagram of a developing device and its vicinity according to the embodiment.

FIG. 3 is a schematic diagram of a developer set according to the embodiment.

### DETAILED DESCRIPTION

### <1. Image Forming Apparatus>

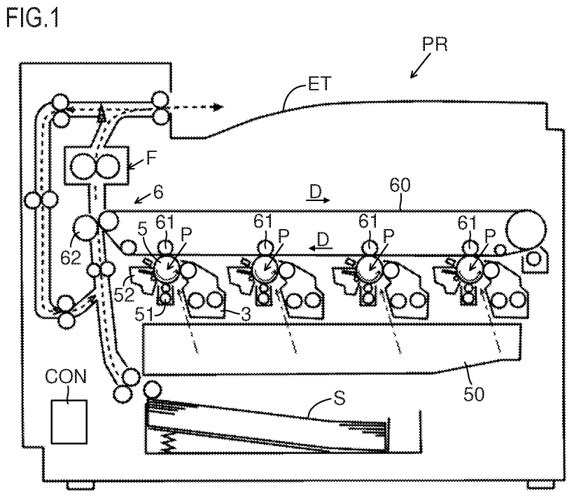

Hereinafter, with reference to FIG. 1, an image forming apparatus PR of this embodiment is described. The image forming apparatus PR is a printer.

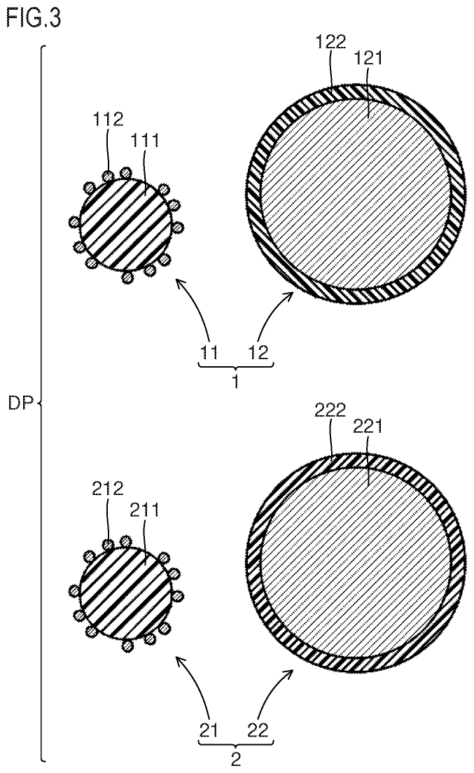

The image forming apparatus PR uses a developer set DP (see FIG. 3), so as to perform electrophotographic printing on a sheet S as a recording medium. As described later in detail, the developer set DP is a set of a first developer 1 and a second developer 2.

The image forming apparatus PR has a conveying path. In FIG. 1, the conveying path is shown by a broken line arrow. The image forming apparatus PR supplies the sheet S stored in a cassette to the conveying path, and conveys the sheet S along the conveying path. In this way, the sheet S passes through a transfer position and a fixing position in this order, and then is discharged onto a discharge tray ET. At the transfer position, a transferring process is performed on the sheet S. At the fixing position, a fixing process is performed on the sheet S.

The image forming apparatus PR includes four image forming units P corresponding to four colors, i.e., cyan, magenta, yellow, and black colors. Each of the image forming units P forms an image using toner of the corresponding color. Hereinafter, one of the image forming units P is noted and a structure thereof is described. The image forming units P have the same basic structure. Therefore, descriptions of structures of other image forming units P are omitted by citing the following description.

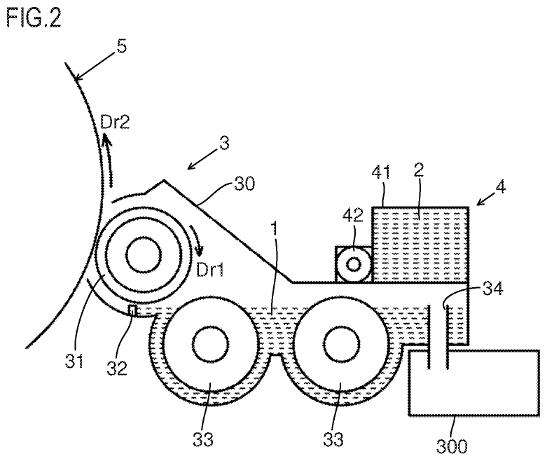

The image forming unit P includes developing device 3. The developing device 3 is connected to a replenishment unit 4 (see FIG. 2). In addition, the image forming unit P includes photosensitive drum 5. The photosensitive drum 5 constitutes one unit together with a charging device 51 and a cleaning device 52. Note that the image forming unit P includes an exposure device 50. The single exposure device 50 is commonly used for the image forming units P.

When the image forming unit P forms an image, the photosensitive drum 5 rotates. The charging device 51 charges the outer peripheral surface of the photosensitive drum 5. The exposure device 50 exposes the outer peripheral surface of the photosensitive drum 5, so as to form an electrostatic latent image on the outer peripheral surface of the photosensitive drum 5. The developing device 3 supplies toner to the electrostatic latent image on the outer peripheral surface of the photosensitive drum 5, so as to develop the electrostatic latent image into a toner image. The replenishment unit 4 replenishes the developer to the developing device 3. The cleaning device 52 removes residual toner on the outer peripheral surface of the photosensitive drum 5.

The image forming apparatus PR includes a transfer unit 6. The transfer unit 6 transfers the toner image on the outer peripheral surface of each photosensitive drum 5 to the sheet S. In other words, the transfer unit 6 transfers the images developed by the developing devices 3 to the sheet S.

The transfer unit 6 includes an intermediate transfer belt 60. The intermediate transfer belt 60 is an endless belt. The intermediate transfer belt 60 contacts the outer peripheral surfaces of the photosensitive drums 5, and in this state, moves (rotates) in the direction shown by an arrow D.

The transfer unit 6 includes primary transfer rollers 61. There are a plurality of the primary transfer rollers 61 each of which is allotted to each of the cyan, magenta, yellow, and black colors. The primary transfer rollers 61 are disposed on an inner peripheral side of the intermediate transfer belt 60. Each of the primary transfer rollers 61 is disposed to face the photosensitive drum 5 carrying the toner image of the corresponding color, via the intermediate transfer belt 60 between them.

In addition, the image forming apparatus PR includes one secondary transfer roller 62. The secondary transfer roller 62 is pressed to contact the outer peripheral surface of the intermediate transfer belt 60 at the transfer position. A transfer nip is formed between the secondary transfer roller 62 and the intermediate transfer belt 60. In other words, the transfer nip is formed at the transfer position.

In a print job, the sheet S is conveyed to the transfer position (i.e., the transfer nip). The sheet S that is being conveyed passes through the transfer nip.

The intermediate transfer belt 60 receives primary transfer of toner images from the photosensitive drums 5. The intermediate transfer belt 60 rotates while carrying the toner images on the outer peripheral surface. When the sheet S is passing through the transfer nip, the sheet S contacts the outer peripheral surface of the intermediate transfer belt 60. In this way, the toner images are secondarily transferred to the sheet S that is passing through the transfer nip.

The image forming apparatus PR includes a fixing unit F. The fixing unit F includes a heating roller and a pressure roller. The heating roller includes a heater inside. The pressure roller is pressed to contact the heating roller. The heating roller and the pressure roller contact each other with pressure so as to form a fixing nip at the fixing position.

In the print job, the sheet S after the transferring process passes through the fixing nip. In other words, the sheet S is sandwiched between the heating roller and the pressure roller at the fixing nip. The fixing unit F heats the sheet S that is passing through the fixing nip. At the fixing nip, the sheet S is pressed. The fixing unit F heats and presses the sheet S after the transferring process, so as to fix the toner image to the sheet S. After the fixing process, the sheet S is discharged onto the discharge tray ET.

### <2. Developing Device>

Hereinafter, with reference to FIG. 2, the developing device 3 of this embodiment is described.

The developing device 3 uses the developer set DP (see FIG. 3) so as to develop the electrostatic latent image. A development method of the developing device 3 is a trickle development method. The developing device 3 receives replenishment of the developer from the replenishment unit 4. In other words, the image forming apparatus PR includes the replenishment units 4 in addition to the developing devices 3. The replenishment unit 4 may be one component of the developing device 3.

The developing device 3 includes a development casing 30. The developer of the developer set DP is stored in the development casing 30. Only the first developer 1 is stored in the development casing 30 in one case, or the first developer 1 and the second developer 2 are mixed and stored in the development casing 30 in another case. The developing device 3 uses the developer stored in the development casing 30 so as to perform development. Note that, for convenience sake, FIG. 2 shows a state where only the first developer 1 is stored in the development casing 30. In the following description, the developer stored in the development casing 30 is referred to as “developer currently in use”.

The developing device 3 includes a developing roller 31. The developing roller 31 is disposed inside the development casing 30 and is supported in a rotatable manner. The outer peripheral surface of the developing roller 31 is partially exposed from inside to outside of the development casing 30. Specifically, the development casing 30 has an opening at a position facing the outer peripheral surface of the photosensitive drum 5. From this opening, the outer peripheral surface of the developing roller 31 is partially exposed to the outside. In this way, the outer peripheral surface of the developing roller 31 and the outer peripheral surface of the photosensitive drum 5 face each other.

The outer peripheral surface of the developing roller 31 carries the developer currently in use, and supplies toner in the developer currently in use to the electrostatic latent image on the outer peripheral surface of the photosensitive drum 5. In this case, the developing roller 31 and the photosensitive drum 5 rotate individually. In FIG. 2, a rotation direction of the developing roller 31 is shown by an arrow Dr1, and a rotation direction of the photosensitive drum 5 is shown by an arrow Dr2.

The developing roller 31 includes a sleeve and a magnet roller. The sleeve is supported in a rotatable manner. An outer peripheral surface of the sleeve carries the developer currently in use. The magnet roller is disposed inside the sleeve (inside the cylinder thereof). The magnet roller is supported in a manner unable to rotate. The magnet roller has a plurality of magnetic poles in the circumferential direction. The sleeve can rotate about an axis of the magnet roller.

The developing device 3 includes a regulating blade 32. The regulating blade 32 is attached to the development casing 30. The regulating blade 32 is disposed so that its distal end part is adjacent to the outer peripheral surface of the developing roller 31. A distal end part of the regulating blade 32 is disposed on an upstream side of the facing area between the developing roller 31 and the photosensitive drum 5, in the rotation direction of the developing roller 31.

The developing device 3 includes two stirring screws 33. Each of the stirring in screws 33 is disposed inside the development casing 30 and is supported in a rotatable manner. Each of the stirring screws 33 has a structure in which a helical blade is disposed on the rotation shaft. Each of the stirring screws 33 rotates so as to stir and convey the developer currently in use, while the toner in the developer currently in use is charged.

During rotation of the developing roller 31, the developer currently in use (specifically, the carrier carrying the toner) is attracted to the outer peripheral surface of the developing roller 31 by a magnetic force of the developing roller 31, and a magnetic brush is formed on the outer peripheral surface of the developing roller 31. When the magnetic brush passes through between the developing roller 31 and the regulating blade 32, the magnetic brush is regulated to have a constant layer thickness.

In addition, a development voltage is applied to the developing roller 31. In this way, a potential difference is generated between the developing roller 31 and the photosensitive drum 5. This potential difference allows the toner in the magnetic brush to move from the developing roller 31 to the photosensitive drum 5. In other words, the toner moves to the electrostatic latent image on the outer peripheral surface of the photosensitive drum 5 (a part whose potential is decreased by exposure). As a result, the electrostatic latent image on the outer peripheral surface of the photosensitive drum 5 is developed into the toner image.

The developing device 3 has a discharge path 34. The discharge path 34 connects the inside of the development casing 30 and a collection box 300. In this way, excess developer currently in use flows into the discharge path 34, moves along the discharge path 34, and reaches the collection box 300. In other words, the collection box 300 stores the excess developer currently in use.

The replenishment unit 4 includes a container 41 and a replenishment member 42. The container 41 stores replenishment developer. The replenishment member 42 replenishes the replenishment developer stored in the container 41 to the developing device 3. For instance, the replenishment member 42 includes a screw shaft. When the screw shaft rotates, the replenishment developer is replenished from the container 41 to the inside of the development casing 30.

Note that the image forming apparatus PR includes a controller unit CON (see FIG. 1). The developing device 3 is equipped with a T/C sensor. The T/C sensor is connected to the controller unit CON. The T/C sensor detects a mixing ratio between the toner and the carrier in the developer currently in use. On the basis of an output of the T/C sensor, the controller unit CON controls replenishment of the replenishment developer from the replenishment unit 4 to the developing device 3. In other words, the controller unit CON controls the replenishment member 42 (to rotate and stop the screw shaft).

The T/C sensor is a magnetic permeability sensor and outputs a value corresponding to a magnetic permeability of the developer currently in use. As the ratio of the carrier in the developer currently in use is higher, the magnetic permeability of the developer currently in use is higher. Utilizing this fact, the mixing ratio between the toner and the carrier in the developer currently in use is detected. Further, a toner remaining amount in the developer currently in use can be detected from the detected mixing ratio.

When starting to use the developing device 3, the development casing 30 already stores initial developer inside. The initial developer is developer stored in the development casing 30 when the image forming apparatus PR is shipped (before a user uses the image forming apparatus PR). In other words, when starting to use the developing device 3, the developer currently in use contains only the initial developer.

After starting use of the developing device 3, when the print job is performed, the developer currently in use is consumed and decreased. In other words, the initial developer is decreased inside the development casing 30. For this reason, after starting use of the developing device 3, the replenishment developer is replenished from the replenishment unit 4 to the developing device 3.

While the image forming apparatus PR continues the print job, the replenishment developer is replenished into the development casing 30 while the developer currently in use is discharged from the inside of the development casing 30. In this way, inside the development casing 30, the developer currently in use is gradually changed, i.e., the initial developer is gradually replaced by the replenishment developer. In other words, the initial developer and the replenishment developer are mixed as the developer currently in use.

### <3. Developer Set>

Hereinafter, with reference to FIG. 3, the developer set DP of this embodiment is described.

The developer set DP contains the first developer 1 and the second developer 2. The first developer 1 and the second developer 2 are stored in the developing device 3 and is used for developing the electrostatic latent image by the developing device 3.

Each of the first developer 1 and the second developer 2 is a two-component developer containing the toner and the carrier. The toner and the carrier of the first developer 1 correspond to a “first toner” and a “first carrier”, respectively. In the following description, the toner and the carrier in the first developer 1 are referred to as the first toner and the first carrier. The toner and the carrier of the second developer 2 correspond to a “second toner” and a “second carrier”. In the following description, the toner and the carrier in the second developer 2 are referred to as the second toner and the second carrier, respectively.

The first toner contains first toner particles 11, and the first carrier contains first carrier particles 12. The second toner contains second toner particles 21, and the second carrier contains second carrier particles 22. The first toner is an aggregate of the first toner particles 11, and the first carrier is an aggregate of the first carrier particles 12. The second toner is an aggregate of the second toner particles 21, and the second carrier is an aggregate of the second carrier particles 22. FIG. 3 schematically illustrate the first toner particle 11, the first carrier particle 12, the second toner particle 21, and the second carrier particle 22, as each single particle.

### <3-1. First Developer>

The first toner particle 11 has a first toner mother particle 111. The first toner mother particle 111 is, for example, a non-encapsulated toner mother particle without a shell layer. The first toner mother particle 111 may be an encapsulated toner mother particle in which a toner core is coated with a shell layer.

The first toner mother particle 111 contains binder resin, for example. As the binder resin, a thermoplastic resin such as polyester resin may be used. The first toner mother particle 111 may contain a coloring agent, a charge control agent, a mold release agent, and the like.

The first toner particle 11 has first external additive particles 112. The first external additive particles 112 adhere to the surface of the first toner mother particle 111. As the first external additive particles 112, silica particles and aluminum oxide particles may be used. In addition, if necessary, resin particles, magnesium oxide particles, zinc oxide particles, and the like may be used as the first external additive particles 112.

In the first toner particle 11, the contained amount of the silica particles is preferably 0.1 pts. mass or more and 10.0 pts. mass or less, and more preferably 0.4 pts. mass or more and 3.0 pts. mass or less, with respect to 100.0 pts. mass of the first toner mother particle 111. In addition, the mean primary particle diameter of the silica particle is preferably 10 nm or more and 30 nm or less, and more preferably 15 nm or more and 25 nm or less. The silica particle may be surface treated.

The contained amount of the aluminum oxide particles in the first toner particle 11 is preferably 0.05 pts. mass or more and 3.0 pts. mass or less, and more preferably 0.3 pts. mass or more and 1.5 pts. mass or less, with respect to 100.0 pts of the first toner mother particle 111. In addition, the mean primary particle diameter of the aluminum oxide particle is preferably 200 nm or more and 600 nm or less, and more preferably 300 nm or more and 500 nm or less.

Note that the mean primary particle diameter in this specification is a mean value of equivalent circle diameters of primary particles measured using a scanning electron microscope (a Heywood diameter: a diameter of a circle having the same area as a projected area of the primary particle). The mean primary particle diameter is, for example, a mean value of equivalent circle diameters of 100 primary particles. For measuring the mean primary particle diameter, a field emission type scanning electron microscope (“JSM-7600F” manufactured by Japan Electron Optics Laboratory Co., Ltd.) can be used.

The first carrier particle 12 has a first carrier core 121. The first carrier core 121 contains magnetic material. As the magnetic material, it is possible to use a metal oxide such as ferrite, magnetite, or maghemite. Note that the ferrite has high flowability and chemical stability tendency. For this reason, it is preferred that the first carrier core 121 contain ferrite. As an example of the ferrite, there are Ba ferrite, Mn ferrite, Mn—Zn ferrite, Ni—Zn ferrite, Mn—Mg ferrite, Ca—Mg ferrite, Li ferrite, and Cu—Zn ferrite. The shape of the first carrier core 121 is not particularly limited, and it may be an irregular shape or a spherical shape.

The first carrier core 121 has a saturation magnetization of 70 emu/g or more. Note that in this specification, the saturation magnetization is a value measured using a sensitive vibrating sample magnetometer (“VSM-P7” manufactured by Toei Industry Co., Ltd.) under the condition of an external magnetic field of 3,000 (Oe). If the first carrier core 121 contains Mn ferrite, there is a tendency that as the content of Mn is higher, the saturation magnetization of the first carrier core 121 is lower. If the first carrier core 121 contains Mn—Mg ferrite, there is a tendency that as the content of Mg is higher, the saturation magnetization of the first carrier core 121 is lower.

Here, if the saturation magnetization of the carrier in the developer currently in use stored in the developing device 3 is high, flowability of the developer currently in use tends to easily decrease, because of an influence of a magnetic field from the developing roller 31, and excessive discharge of the developer currently in use through the discharge path 34 is suppressed. For this reason, it is preferred that the saturation magnetization of the carrier in the developer currently in use be 70 emu/g or more. In other words, it is preferred that the saturation magnetization of the first carrier core 121 be 70 emu/g or more. In this way, the mixing ratio between the toner and the carrier in the developer currently in use can be accurately detected, and hence the remaining amount of the developer currently in use in the developing device 3 is stabilized.

The first carrier particle 12 has a first coat layer 122. The first coat layer 122 covers the surface of the first carrier core 121. For instance, the entire surface of the first carrier core 121 is covered with the first coat layer 122. The first coat layer 122 contains silicone resin as a main component. In other words, a main component of the first coat layer 122 in mass base is silicone resin. The constituent resin of the coat layer 122 may consist essentially of silicone resin, or in another embodiment, may contain other resins in addition to the silicone resin.

As a preferred example of the silicone resin, there are silicone resin having a methyl group, and epoxy modified silicone resin. An example of the silicone resin having a methyl group is a silicone resin that has a methyl group but does not have a phenyl group. Another example of the silicone resin having a methyl group is a silicone resin that has a methyl group and a phenyl group.

The first coat layer 122 contains barium titanate particles. The contained amount of the barium titanate particles in the first coat layer 122 is 2 pts. mass or more and 47 pts. mass or less, and preferably 3 pts. mass or more and 35 pts. mass or less, and more preferably 10 pts. mass or more and 25 pts. mass or less, with respect to 100 pts. mass of the silicone resin. The mean primary particle diameter of the barium titanate particle is 100 nm or more and 500 nm or less, and preferably 150 nm or more and 450 nm or less, and more preferably 250 nm or more and 350 nm or less.

The first coat layer 122 contains carbon black particles. The contained amount of the carbon black particles is 4 pts. mass or less with respect to 100 pts. mass of the silicone resin. The mean primary particle diameter of the carbon black particle is 10 nm or more and 80 nm or less, and preferably 30 nm or more and 45 nm or less.

Because the first coat layer 122 contains the carbon black particles, charges move smoothly from the first carrier particles 12 to the first toner particles 11, and hence the first toner particles 11 can be charged to a desired charge amount. If the first developer 1 and the second developer 2 are mixed, charges move smoothly from the first carrier particle 12 to the first toner particle 11 and the second toner particle 21, and hence the first toner particle 11 and the second toner particle 21 can be charged to a desired charge amount. In this way, an image having a desired image density and little fogging can be formed.

The first coat layer 122 is formed by firing a raw material of the first coat layer 122. Coating liquid as the raw material of the first coat layer 122 contains silicone resin solution. Barium titanate particles and carbon black particles are added to the silicone resin solution.

### <3-2. Second Developer>

The second toner particle 21 is the same toner particle as the first toner particle 11. In other words, the second toner particle 21 has a second toner mother particle 211 and second external additive particles 212 adhered to the surface of the second toner mother particle 211. Further, the second toner mother particle 211 is the same as the first toner mother particle 111. In addition, the second external additive particle 212 is the same as the first external additive particle 112. For this reason, description of the second toner particle 21 (the second toner mother particle 211 and the second external additive particles 212) is omitted by citing the description of the first toner particle 11 (the first toner mother particle 111 and the first external additive particles 112).

The second carrier particle 22 have a second carrier core 221. The second carrier core 221 has a saturation magnetization of 70 emu/g or more. Note that the second carrier core 221 is the same carrier core as the first carrier core 121. For this reason, description of the second carrier core 221 is omitted by citing the description of the first carrier core 121.

The second carrier particle 22 has a second coat layer 222. The second coat layer 222 covers the surface of the second carrier core 221. The second coat layer 222 is made of the same raw material (coating liquid) as the first coat layer 122. For this reason, description of the second coat layer 222 is omitted by citing the description of the first coat layer 122.

The second coat layer 222 contains barium titanate particles. The contained amount of the barium titanate particles in the second coat layer 222 is the same as the contained amount of the barium titanate particles in the first coat layer 122. In addition, the barium titanate particles in the second coat layer 222 are the same particles as the barium titanate particles in the first coat layer 122. For this reason, description of the barium titanate particles in the second coat layer 222 is omitted by citing the description of the barium titanate particles in the first coat layer 122.

The second coat layer 222 contains carbon black particles. The contained amount of the carbon black particles in the second coat layer 222 is the same as the contained amount of the carbon black particles in the first coat layer 122. In addition, the carbon black particles in the second coat layer 222 are the same particles as the carbon black particles in the first coat layer 122. For this reason, the description of the carbon black particles in the second coat layer 222 is omitted by citing the description of the carbon black particles in the first coat layer 122.

Here, the second coat layer 222 is harder than the first coat layer 122, though the raw material (coating liquid) thereof is the same as the raw material of the first coat layer 122. Specifically, the second coat layer 222 is formed by firing the raw material of the second coat layer 222 under firing conditions different from those when firing the raw material of the first coat layer 122. In this way, the hardness of the second coat layer 222 is higher than that of the first coat layer 122.

For instance, in this specification, the hardness of the coat layer is defined as a spring constant (N/m) measured by a scanning probe microscope SPM (“S-image” manufactured by Hitachi High-Tech Science Corporation). For instance, the spring constant of the coat layer can be obtained by a method including the steps of applying the raw material (coating liquid) of the coat layer onto a predetermined plate using a spin coater so as to fire the same, and measuring the spring constant of the coat layer on the plate using the scanning probe microscope. The second coat layer 222 is formed under firing conditions different from those of the first coat layer 122, and hence has a larger spring constant (N/m) as the hardness measured by the scanning probe microscope than the first coat layer 122.

In the following description, the spring constant measured by the scanning probe microscope is simply referred to as a spring constant. The spring constants of the first coat layer 122 and the second coat layer 222 each correspond to the hardness thereof. As the spring constant is larger, the hardness is higher, while as the spring constant is smaller, the hardness is lower.

It is preferred that the spring constants of the first coat layer 122 and the second coat layer 222 be each 20 N/m or more and 140 N/m or less. In addition, it is preferred that the spring constant of the second coat layer 222 be larger than that of the first coat layer 122 by 5 N/m or more.

Note that the value defined as the hardness of the coat layer is not particularly limited. For instance, it may be possible to define the hardness of the coat layer as a value measured using another instrument such as a pencil hardness tester or a microhardness tester.

In this embodiment, because the second coat layer 222 is harder than the first coat layer 122, durability of the developer currently in use is improved when the second developer 2 is replenished to the developing device 3. Specifically, because the coat layer is hard, it is possible to suppress adhesion of the external additive particles of the toner to the carrier particle including the coat layer. In this way, characteristics of the carrier is hardly changed, and deterioration of toner chargeability due to a change in characteristics of the carrier is suppressed. As a result, it is possible to suppress occurrence of fogging due to adhesion of toner to a non-image area of the photosensitive drum 5 (in other words, fogging due to adhesion of toner to a white area of the sheet S).

Supposing the case where only the second developer 2 is used from beginning of use of the developing device 3 (in other words, the case where only the second developer 2 constitutes the developer currently in use), flowability of the developer currently in use is so high that the developer currently in use is easy to roll, which causes a phenomenon that the toner is excessively charged. For this reason, charging characteristics of the developer currently in use is deteriorated in the early stage of use of the developing device 3.

Therefore, in this embodiment, the first developer 1 is used as the initial developer, and the second developer 2 is used as the replenishment developer. In this embodiment, because the initial developer has a lower hardness of the coat layer than the replenishment developer, it is possible to suppress deterioration of charging characteristics of the developer currently in use in the early stage of use of the developing device 3. Thus, in this embodiment, it is possible to improve durability of the developer currently in use, while suppressing deterioration of charging characteristics of the developer currently in use in the early stage of use of the developing device 3.

In addition, in this embodiment, the first toner particle 11 and the second toner particle 21 are the same toner particle. Further, the first carrier core 121 and the second carrier core 221 are the same carrier core. In this way, it is possible to suppress an increase in manufacturing cost of the developer set DP.

In addition, in this embodiment, the first coat layer 122 and the second coat layer 222 are made of the same raw material. In this way, although the first coat layer 122 and the second coat layer 222 have different hardnesses, it is possible to suppress an increase in manufacturing cost of the developer set DP.

Further, in this embodiment, the same raw material (coating liquid) is used for the first coat layer 122 and the second coat layer 222, while different firing conditions of the coating liquid are used for the first coat layer 122 and the second coat layer 222. In this way, even the same raw material is used for the first coat layer 122 and the second coat layer 222, it is easy to make the second coat layer 222 harder than the first coat layer 122.

There are a plurality of firing conditions of the coating liquid for each of the first coat layer 122 and the second coat layer 222, and if at least one of the plurality of firing conditions is different, it is possible to make the second coat layer 222 harder than the first coat layer 122. For instance, by using different firing temperatures (as one of the firing conditions) of the coating liquid for the first coat layer 122 and the second coat layer 222, it is possible to make the second coat layer 222 harder than the first coat layer 122. Alternatively, by setting different firing time periods (as one of the firing conditions) of the coating liquid for the first coat layer 122 and the second coat layer 222, it is possible to make the second coat layer 222 harder than the first coat layer 122.

As another example, by using different raw materials for the first coat layer 122 and the second coat layer 222, it is possible to make the second coat layer 222 harder than the first coat layer 122. However, in this case, it is necessary to prepare different materials for the first coat layer 122 and the second coat layer 222.

Further, in this embodiment, the contained amount of the second carrier contained in the second developer 2 is 7.5 pts. mass or less with respect to 100 pts. mass of the second toner. As the amount of the carrier in the developer is smaller, the cost can be lower, and hence it is preferred that the contained amount of the second carrier be smaller. If the contained amount of the second carrier is 7.5 pts. mass or less, the cost can be reduced.

### <4. Confirmation Experiment>

Hereinafter, an experiment is described, which was performed for confirming effects of use of the developer set DP according to this embodiment. In the confirmation experiment, the developer set DP (the first developer 1 and the second developer 2) was manufactured, printing was performed using the developer set DP, and states of printed images were checked.

### <4-1. Preparation of Toner>

The toner to be used for the confirmation experiment was prepared by the following method.

### <4-1-1. Synthesis of Amorphous Polyester Resin>

A reaction container, equipped with a thermometer (thermocouple), a dewatering conduit, a nitrogen gas introduction conduit, and a stirring device (stirring blade), was set to an oil bath. Then, 1,575 g of bisphenol A propylene oxide additive (BPA-PO), 163 g of bisphenol A ethylene oxide additive (BPA-EO), 377 g of fumaric acid, and 4 g of catalyst (dibutyltin oxide) were put into the reaction container.

After creating a nitrogen atmosphere in the reaction container, the temperature inside the reaction container was raised to 220 degrees Celsius while stirring the contents. Under the conditions of the nitrogen atmosphere and the temperature of 220 degrees Celsius, polymerization reaction of the contents in the reaction container was performed for 8 hours while removing by-product water. Next, the pressure inside the reaction container is reduced, and under the conditions of the reduced pressure atmosphere (pressure: 7,999 Pa) and the temperature of 220 degrees Celsius, the polymerization reaction of the contents in the reaction container was performed for more 1 hour. In addition, the temperature inside the reaction container was reduced to 210 degrees Celsius, and then 336 g of trimellitic anhydride was added into the reaction container. Then, under the conditions of the reduced pressure atmosphere (pressure: 7,999 Pa) and the temperature of 210 degrees Celsius, reaction of the contents in the reaction container was performed. After that, the reaction product was taken out from the reaction container and was cooled, and hence the amorphous polyester resin having the following physical properties was obtained. Note that the polyester resin obtained in this way did not clearly show its endothermic peak in the endothermic curve measured using a differential scanning calorimeter, and its clear melting point was not able to be measured, and thus it was determined to be amorphous.
softening point (Tm): 100 degrees Celsius
glass transition point (Tg): 50 degrees Celsius
mass average molecular weight (Mw): 30,000
acid value: 15 mgKOH/g
hydroxyl value: 30 mgKOH/g

### <4-1-2. Preparation of Toner Mother Particles>

Using an FM mixer (“FM-10B” manufactured by Nippon Coke & Engineering Co., Ltd.), 100 pts. mass of binder resin, 4 pts. mass of coloring agent, 1 pts. mass of charge control agent, and 5 pts. mass of mold release agent were mixed, so that the mixture was obtained. As the binder resin, the amorphous polyester resin described above was used. As the coloring agent, copper phthalocyanine blue pigment (C.I. Pigment Blue 15:3) was used. As the charge control agent, quaternary ammonium salt (“BONTRON (registered trademark) P-51” manufactured by Orient Chemical Industries Co., Ltd.) was used. As the mold release agent, carnauba wax (“Special Carnauba Wax 1st” manufactured by S. KATO & CO.) was used.

Next, using a twin-screw extruder (“PCM-30 type” manufactured by Ikegai Co., Ltd.), the mixture was melted and kneaded, so that the melted and kneaded material was obtained. In addition, using a mechanical pulverizer (“Turbo Mill” manufactured by Freund-Turbo Corporation), the melted and kneaded material was pulverized, so that the pulverized material was obtained. Then, using a classifier (“Elbow Jet” manufactured by Nittetsu Mining Co., Ltd.), the pulverized material was classified. In this way, powder-like toner mother particles having a volume median diameter of 6.8 μm were obtained. Note that the volume median diameter (D₅₀) is a median diameter measured using a laser diffraction/scattering type particle size distribution measurement device (“LA-950” manufactured by HORIBA, Ltd.).

### <4-1-3. External Addition to Toner Mother Particles>

Using the FM mixer (“FM-10B” manufactured by Nippon Coke & Engineering Co., Ltd.), 100.0 pts. mass of the toner mother particle described above, 1.0 pts. mass of the silica particles (mean primary particle diameter: 20 nm), and 0.75 pts. mass of aluminum oxide particles (“AEROXIDE (registered trademark) Alu C805” manufactured by Nippon Aerosil Co., Ltd., BET specific surface area: 75 to 105 m2/g) were mixed for 5 minutes under the condition of 4,000 rpm, so that the mixture was obtained. Note that the mean primary particle diameter of the aluminum oxide particles is more than 300 nm. Then, using a sieve of 200 mesh (aperture of 75 μm), the mixture was sieved, and the toner shown in Table 1 was obtained. In the table referred to by the following description, the toner is shown by “T”.

TABLE 1
toner (T)

| mother | external additive particle | |
|---|---|---|
| particle | alumina particle | silica particle |

| pts. mass | pts. mass | pts. mass | diameter (nm) |
|---|---|---|---|
| 100 | 0.75 | 1 | 20 |

### <4-2. Preparation of Carrier>

The carrier to be used for the confirmation experiment was prepared by the following method.

### <4-2-1. Preparation of Coating Liquid>

The silicone resin solution, the barium titanate particles, the carbon black particles, and toluene were put into a stainless steel container. Then, using a homogenizer, the contents in the stainless steel container were mixed, so that the coating liquid was obtained. As the silicone resin solution, “KR-255” manufactured by Shin-Etsu Chemical Co., Ltd. (solid content: methylphenyl silicone resin, solid content concentration: 50 mass %) was used. As the barium titanate particle, “BT-01” manufactured by Sakai Chemical Industry Co., Ltd. (mean primary particle diameter: 304 nm) was used. As the carbon black particle, “Ketjenblack (registered trademark) EC300J” manufactured by LION SPECIALTY CHEMICALS CO., Ltd. (mean primary particle diameter: 39.5 nm), which is conductive carbon black, was used.

### <4-2-2. Preparation of Carrier Particles>

Using a fluid bed coating machine (“FD-MP-01 D type” manufactured by Powrex Corporation), 5,000 g of the carrier cores were allowed to flow, while the coating liquid was sprayed to the carrier cores. In this way, the carrier cores coated with the coating liquid were obtained. In this case, as the carrier cores, manganese ferrite cores (manufactured by DOWA IP Creation Co., Ltd., volume median diameter: 40 μm) were used. In addition, the amount of the coating liquid input to the fluid bed coating machine was adjusted, so that the mass of the coat layer (the layer obtained by heating the coating liquid) became 15 g with respect to 1,000 g of the carrier core. Next, using an electric furnace, the carrier cores coated with the coating liquid were fired for 1 hour, so that the coat layer was formed on the surface of the carrier core. In this way, the carrier particles were obtained.

Here, in the confirmation experiment, six types of the carriers C1, C2, C3, C4, C5, and C6 were used. Characteristics of the carriers are shown in Table 2.

TABLE 2
carrier

| | | saturation | | firing | spring |
|---|---|---|---|---|---|
| | | magnetization | CB amount | temperature | constant |
| example | type | (emu/g) | (pts. mass) | (° C.) | (N/m) |
| 1, 2 | C1 | 80 | 3 | 200 | 42 |
| | C2 | 80 | 3 | 230 | 64 |
| 3 | C3 | 60 | 3 | 200 | 42 |
| | C4 | 60 | 3 | 230 | 64 |
| 4 | C5 | 80 | 5 | 200 | 42 |
| | C6 | 80 | 5 | 230 | 64 |

As shown in Table 2, the saturation magnetizations of the carrier cores of the carriers C1, C2, C5, and C6 are 80 emu/g. In other words, the saturation magnetizations of the carrier cores of the carriers C1, C2, C5, and C6 are 70 emu/g or more. On the other hand, the saturation magnetizations of the carrier cores of the carriers C3 and C4 are 60 emu/g.

The contained amount of the carbon black particles in each of the coat layers of the carriers C1 to C4 is 3 pts. mass with respect to 100 pts. mass of the silicone resin. In other words, the contained amount of the carbon black particles in each of the coat layers of the carriers C1 to C4 is 4 pts. mass or less with respect to 100 pts. mass of the silicone resin. On the other hand, the contained amount of the carbon black particles in each of the coat layers of the carriers C5 and C6 is 5 pts. mass with respect to 100 pts. mass of the silicone resin.

The carriers C1, C3, and C5 were fired in the same firing conditions (here, referred to as a first firing conditions). The carriers C2, C4, and C6 were fired in the same firing conditions (here, referred to as a second firing conditions), which are different from the first firing conditions. The firing temperature is different between the first firing conditions and the second firing conditions. The firing temperature of the first firing conditions is 200 degrees Celsius, and the firing temperature of the second firing conditions is 230 degrees Celsius, which is higher than the firing temperature of the first firing conditions.

Because the second firing conditions have higher firing temperature than the first firing condition, the hardness of each coat layer of the carriers C2, C4, and C6 is higher than the hardness of each coat layer of the carriers C1, C3, and C5. Specifically, in measurement by the scanning probe microscope (“S-image” manufactured by Hitachi High-Tech Science Corporation), the spring constant of the coat layer obtained by the first firing conditions is 42 N/m, while the spring constant of the coat layer obtained by the second firing conditions is 64 N/m. In this way, it can be said that each coat layer of the carriers C2, C4, and C6 is harder than each coat layer of the carriers C1, C3, and C5.

### <4-3. Preparation of Developer>

The developer sets (combinations of the toner and the carrier) in Examples and Comparative Examples are shown in Table 3.

TABLE 3

| | | | replenishment developer | | |
|---|---|---|---|---|---|
| | initial developer | | | | carrier amount |
| | toner | carrier | toner | carrier | (pts. mass) |
| Example 1 | T | C1 | T | C2 | 5 |
| Example 2 | T | C1 | T | C2 | 10 |
| Example 3 | T | C3 | T | C4 | 5 |
| Example 4 | T | C5 | T | C6 | 5 |
| Comparative | T | C1 | T | C1 | 5 |
| Example 1 | | | | | |
| Comparative | T | C2 | T | C2 | 5 |
| Example 2 | | | | | |

In Example 1, the toner T and the carrier C1 were mixed, and the initial developer was obtained. In addition, the toner T and the carrier C2 were mixed, and the replenishment developer was obtained. In this way, in Example 1, the coat layer of the carrier of the replenishment developer is harder than that of the initial developer.

Further, in Example 1, the contained amount of the carrier contained in the replenishment developer is 5 pts. mass with respect to 100 pts. mass of the toner. In other words, in Example 1, the contained amount of the carrier contained in the replenishment developer is 7.5 pts. mass or less with respect to 100 pts. mass of the toner.

Note that as shown in Table 2, in Example 1, the saturation magnetization of each carrier core of the initial developer and the replenishment developer is 80 emu/g. In addition, in Example 1, the contained amount of the carbon black particles in each coat layer of the initial developer and the replenishment developer is 3 pts. mass (i.e., 4 pts. mass or less), with respect to 100 pts. mass of the silicone resin.

In Example 2, the toner T and the carrier C1 were mixed, so that the initial developer was obtained. In addition, the toner T and the carrier C2 were mixed, so that the replenishment developer was obtained. In other words, in Example 2, in the same manner as in Example 1, the coat layer of the carrier of the replenishment developer is harder than that of the carrier of the initial developer.

In addition, in Example 2, the contained amount of the carrier contained in the replenishment developer is 10 pts. mass, with respect to 100 pts. mass of the toner. In other words, in Example 2, unlike in Example 1, the contained amount of the carrier contained in the replenishment developer is more than 7.5 pts. mass, with respect to 100 pts. mass of the toner.

Note that as shown in Table 2, in Example 2, the saturation magnetization of each carrier core of the initial developer and the replenishment developer is 80 emu/g, which is the same as in Example 1. In addition, in Example 2, in the same manner as in Example 1, the contained amount of the carbon black particles in each coat layer of the initial developer and the replenishment developer is 3 pts. mass (i.e., 4 pts. mass or less), with respect to 100 pts. mass of the silicone resin.

In Example 3, the toner T and the carrier C3 were mixed, so that the initial developer was obtained. In addition, the toner T and the carrier C4 were mixed, so that the replenishment developer was obtained. In other words, in Example 3, in the same manner as in Example 1, the coat layer of the carrier of the replenishment developer is harder than that of the carrier of the initial developer.

In addition, in Example 3, the contained amount of the carrier contained in the replenishment developer is 5 pts. mass with respect to 100 pts. mass of the toner. In other words, in Example 3, in the same manner as in Example 1, the contained amount of the carrier contained in the replenishment developer is 7.5 pts. mass or less with respect to 100 pts. mass of the toner.

Note that as shown in Table 2, in Example 3, the saturation magnetization of each carrier core of the initial developer and the replenishment developer is 60 emu/g, which is smaller than in Example 1. In addition, in Example 3, in the same manner as in Example 1, the contained amount of the carbon black particles in each coat layer of the initial developer and the replenishment developer is 3 pts. mass (i.e., 4 pts. mass or less), with respect to 100 pts. mass of the silicone resin.

In Example 4, the toner T and the carrier C5 were mixed, so that the initial developer was obtained. In addition, the toner T and the carrier C6 were mixed, so that the replenishment developer was obtained. In other words, in Example 4, in the same manner as in Example 1, the coat layer of the carrier of the replenishment developer is harder than that of the carrier of the initial developer.

In addition, in Example 4, the contained amount of the carrier contained in the replenishment developer is 5 pts. mass with respect to 100 pts. mass of the toner. In other words, in Example 4, in the same manner as in Example 1, the contained amount of the carrier contained in the replenishment developer is 7.5 pts. mass or less with respect to 100 pts. mass of the toner.

Note that as shown in Table 2, in Example 4, the saturation magnetization of each carrier core of the initial developer and the replenishment developer is 80 emu/g, which is the same as in Example 1. In addition, in Example 4, unlike in Example 1, the contained amount of the carbon black particles in each coat layer of the initial developer and the replenishment developer is 5 pts. mass (i.e., is more than 4 pts. mass), with respect to 100 pts. mass of the silicone resin.

In Comparative Example 1, the toner T and the carrier C1 were mixed, so that the initial developer was obtained. In addition, the toner T and the carrier C1 were mixed, so that the replenishment developer was obtained. In other words, in Comparative Example 1, unlike in Examples 1 to 4, the carriers of the initial developer and the replenishment developer have the same hardness of the coat layer.

In addition, in Comparative Example 1, the contained amount of the carrier contained in the replenishment developer is 5 pts. mass with respect to 100 pts. mass of the toner. In other words, in Comparative Example 1, in the same manner as in Example 1, the contained amount of the carrier contained in the replenishment developer is 7.5 pts. mass or less with respect to 100 pts. mass of the toner.

Note that in Comparative Example 1, the saturation magnetization of each carrier core of the initial developer and the replenishment developer is 80 emu/g, which is the same as in Example 1. In addition, in Comparative Example 1, in the same manner as in Example 1, the contained amount of the carbon black particles in each coat layer of the initial developer and the replenishment developer is 3 pts. mass, with respect to 100 pts. mass of the silicone resin.

In Comparative Example 2, the toner T and the carrier C2 were mixed, so that the initial developer was obtained. In addition, the toner T and the carrier C2 were mixed, so that the replenishment developer was obtained. In other words, in Comparative Example 2, unlike in Examples 1 to 4, the initial developer and the replenishment developer have the same hardness of the coat layer of the carrier. In Comparative Example 2, the hardness of the coat layer of the carrier in the initial developer and the replenishment developer is higher than in Comparative Example 1.

In addition, in Comparative Example 2, the contained amount of the carrier contained in the replenishment developer is 5 pts. mass with respect to 100 pts. mass of the toner. In other words, in Comparative Example 2, in the same manner as in Example 1, the contained amount of the carrier contained in the replenishment developer is 7.5 pts. mass or less with respect to 100 pts. mass of the toner.

Note that in Comparative Example 2, the saturation magnetization of each carrier core of the initial developer and the replenishment developer is 80 emu/g, which is the same as in Example 1. In addition, in Comparative Example 2, in the same manner as in Example 1, the contained amount of the carbon black particles in each coat layer of the initial developer and the replenishment developer is 3 pts. mass with respect to 100 pts. mass of the silicone resin.

### <4-4. Evaluation>

For each developer set in each Example and each Comparative Example, as shown in the following Table 4, “initial ID deterioration”, “endurance fogging”, and “density stability” were evaluated. Note that in Table 4, the grade A indicates being very good, the grade B indicates being good (a level without any problem on the image), and the grade C indicates being not good (a level having a problem on the image).

TABLE 4

| | initial ID | endurance | density |
|---|---|---|---|
| | deterioration | fogging | stability |
| Example 1 | B | B | A |
| Example 2 | B | B | A |
| Example 3 | B | B | B |
| Example 4 | B | B | B |
| Comparative | B | C | C |
| Example 1 | | | |
| Comparative | C | B | C |
| Example 2 | | | |

As an evaluation machine, an image forming apparatus (manufactured by KYOCERA Document Solutions Inc.) was used, which is equipped with the developing device having the structure illustrated in FIG. 2. When performing the print job, the initial developer was stored in the developing device (inside the development casing) of the evaluation machine, and the replenishment developer was stored in the replenishment unit (container) of the evaluation machine. In this state, the print job was started so as to print an image (that is a solid patch image) on 300,000 sheets. Note that the same image was printed on the sheets. Therefore, ideally the sheets have the same image density. In addition, ideally the toner does not adhere to the non-image area of each sheet.

For the evaluation of the “initial ID deterioration”, a reflection densitometer (“SpectroEye (registered trademark)” manufactured by X-Rite Incorporated) was used so as to measure image density (specifically, solid patch image density) of the printed sheets. Here, the image density of the first sheet to the 10,000th sheet is referred to as a first density, while the image density after the 10,000th sheet is referred to as a second density, and the first density and the second density were compared. Then, the evaluation was performed by the following criteria.
B: The deterioration of the first density with respect to the second density is less than 0.4.
C: The deterioration of the first density with respect to the second density is 0.4 or more.

For the evaluation of the “endurance fogging”, a white color photometer (“TC-6DS” manufactured by Tokyo Denshoku Ltd.) was used so as to measure reflection density (D) of a blank area of each of the printed sheets. In addition, reflection density (Do) of an unprinted sheet was measured, and fogging density (=D-Do) was calculated. Then, the evaluation was performed by the following criteria.
B: The fogging density is 0.01 or less.
C: The fogging density is more than 0.01.

For the evaluation of the “density stability”, a reflection densitometer (“SpectroEye (registered trademark)” manufactured by X-Rite Incorporated) was used so as to measure the image density (specifically, the solid patch image density) of the printed sheets. In addition, it was determined how much the image density has changed from the first sheet printing to the 300,000th sheet printing (here, referred to as an ID change). Then, the evaluation was performed by the following criteria.
A: The ID change is ±0.2 or less.
B: The ID change is ±0.3 or less.
C: The ID change is beyond ±0.3.

First, it was confirmed that the “initial ID deterioration” was a level without any problem in Examples 1 to 4. Specifically, in Examples 1 to 4, the deterioration of the first density with respect to the second density was less than 0.4 for any one of the first to 10,000th sheets.

On the other hand, in Comparative Example 2, the “initial ID deterioration” was a level having a problem. Note that in Comparative Example 1, in the same manner as in Examples 1 to 4, the “initial ID deterioration” was a level without any problem. Here, in Comparative Example 2, unlike in Examples 1 to 4 and Comparative Example 1, the spring constant of the coat layer of the initial developer is 64 N/m, and the hardness is high in the same manner as the coat layer of the replenishment developer. In other words, in Comparative Example 2, the flowability of the initial developer is high, which easily causes the phenomenon that the toner is excessively charged. For this reason, in Comparative Example 2, it is considered that the “initial ID deterioration” became a level having a problem.

In addition, it was confirmed that the “endurance fogging” was a level without any problem in Examples 1 to 4. Specifically, in Examples 1 to 4, there was no printed sheet having a fogging density more than 0.01.

On the other hand, in Comparative Example 1, the “endurance fogging” was a level having a problem. Note that in Comparative Example 2, in the same manner as in Examples 1 to 4, the “endurance fogging” was a level without any problem. Here, in Comparative Example 1, unlike in Examples 1 to 4 and Comparative Example 2, the spring constants of the coat layers of the initial developer and the replenishment developer are both as low as 42 N/m. In other words, in Comparative Example 1, durability of the carrier is low, and toner chargeability tends to be deteriorated. For this reason, in Comparative Example 1, it is considered that the “endurance fogging” was a level having a problem.

In addition, it was confirmed that the “density stability” was a level without any problem in Examples 1 to 4. Specifically, in Examples 1 to 4, there was no printed sheet having an ID change beyond ±0.3. On the other hand, in both Comparative Examples 1 and 2, the “density stability” was a level having a problem.

From these results, it can be said that the use of the developer set of Examples 1 to 4 is preferred. Note that the initial developer of Examples 1 to 4 corresponds to the first developer 1, and the replenishment developer of Examples 1 to 4 corresponds to the second developer 2. In other words, it can be said that by using the first developer 1 as the initial developer, and by using the second developer 2 as the replenishment developer, durability of the developer currently in use can be improved, while suppressing deterioration of charging characteristics in the early stage of the developer currently in use.

Note that comparing Example 3 with Examples 1 and 2, the “density stability” had a better result in Examples 1 and 2. Here, in Examples 1 and 2, the saturation magnetization of the carrier core is 80 emu/g (i.e., 70 emu/g or more), while in Example 3, the saturation magnetization of the carrier core is 60 emu/g. From this fact, it can be said that the saturation magnetization of the carrier core is preferably 70 emu/g or more.

Further, also in comparison between Example 4 and Examples 1 and 2, the “density stability” had a better result in Examples 1 and 2. Here, in Examples 1 and 2, the contained amount of the carbon black particles in the coat layer is 3 pts. mass (i.e., 4 pts. mass or less) with respect to 100 pts. mass of the silicone resin, while in Example 4, the contained amount of the carbon black particles in the coat layer is 5 pts. mass with respect to 100 pts. mass of the silicone resin. From this fact, it can be said that the contained amount of the carbon black particles in the coat layer is preferably 4 pts. mass or less with respect to 100 pts. mass of the silicone resin.

In addition, both in Examples 1 and 2, the “initial ID deterioration”, the “endurance fogging”, and the “density stability” had good results. Here, in Examples 1 and 2, the same toner was used, and the same carrier was used. However, in Example 1, the contained amount of the carrier contained in the replenishment developer is 5 pts. mass (i.e., 7.5 pts. mass or less) with respect to 100 pts. mass of the toner. On the other hand, in Example 2, the contained amount of the carrier contained in the replenishment developer is 10 pts. mass with respect to 100 pts. mass of the toner. From this fact, in consideration of reduction in running cost, it can be said that the contained amount of the carrier contained in the replenishment developer is preferably 7.5 pts. mass or less with respect to 100 pts. mass of the toner.

The embodiments disclosed this time are examples in every aspect and should not be interpreted as limitations. The scope of the present disclosure is defined not by the above description of the embodiments but by the claims, and further, should be understood to include all modifications within meaning and scope equivalent to the claims.

What is claimed is:

1. A developer set used for developing an electrostatic latent image by a developing device, the developer set comprising:
a first developer stored in the developing device from beginning of use of the developing device; and
a second developer to be replenished to the developing device after starting use of the developing device, wherein
the first developer contains a first toner and a first carrier containing first carrier particles,
the second developer contains a second toner and a second carrier containing second carrier particles,
the first carrier particle has a first carrier core and a first coat layer whose main component is silicone resin, the first coat layer covering the first carrier core, and
the second carrier particle has a second carrier core and a second coat layer whose main component is silicone resin, the second coat layer being harder than the first coat layer and covering the second carrier core.

2. The developer set according to claim 1, wherein the first toner and the second toner are the same toner.

3. The developer set according to claim 1, wherein
the first carrier core and the second carrier core are the same carrier core, and
the first carrier core and the second carrier core each have a saturation magnetization of 70 emu/g or more.

4. The developer set according to claim 1, wherein
the first coat layer and the second coat layer each contain carbon black particles, and
the contained amount of the carbon black particles in each of the first coat layer and the second coat layer is 4 pts. mass or less with respect to 100 pts. mass of the silicone resin.

5. The developer set according to claim 1, wherein
the first coat layer and the second coat layer are made of the same raw material,
the first coat layer is formed by firing the raw material of the first coat layer, and
the second coat layer is formed by firing the raw material of the second coat layer under firing conditions different from those when firing the raw material of the first coat layer.

6. The developer set according to claim 1, wherein the contained amount of the second carrier contained in the second developer is 7.5 pts. mass or less with respect to 100 pts. mass of the second toner.

7. An image forming apparatus comprising:
a developing device configured to use the developer set according to claim 1, so as to develop an electrostatic latent image;
a transfer unit configured to transfer the image developed by the developing device to a sheet; and
a replenishment unit, wherein
the developing device stores the first developer from beginning of use of the developing device, and
the replenishment unit stores the second developer and replenishes the second developer to the developing device after starting use of the developing device.
